(19) United States
(12) Patent Application Publication
(10) Pub. No.: US 2013/0210305 A1
(43) Pub. Date: Aug. 15, 2013

(54) UNBALANCED WOVEN ADHESIVE TAPE

(71) Applicants: David S. Cosgrove, Jonesville, SC (US); William C. Gadson, Union, SC (US); Phillip R. Keener, Chapin, SC (US); Scott Hunter, Simpsonville, SC (US)

(72) Inventors: David S. Cosgrove, Jonesville, SC (US); William C. Gadson, Union, SC (US); Phillip R. Keener, Chapin, SC (US); Scott Hunter, Simpsonville, SC (US)

(21) Appl. No.: 13/396,869

(22) Filed: Feb. 15, 2012

(51) Int. Cl. B32B 27/04; D06B 1/00; D03D 41/00

(52) U.S. Cl. 442/149; 139/11; 28/169

(57) ABSTRACT

A tape containing an unbalanced woven fabric and an adhesive. The woven fabric has a warp dominant face and a filling dominant face, a plurality of warp yarns in a warp direction, and a plurality of filling yarns in a filling direction perpendicular to the warp direction crossing with the warp yarns at a plurality of intersections. At least 55% by number of the intersections have the warp yarn crossing with the filling yarn such that the warp yarn is on the warp dominant face of the fabric. At least 55% by number of the intersections have the warp yarn crossing with the filling yarn such that the filling yarn is on the filling dominant face of the fabric. The warp yarns have a linear mass density of between about 30 and 100 denier and the filling yarns have a linear mass density of between about 70 and 600 denier.

### FIELD OF THE INVENTION

The present invention generally relates to adhesive tapes. More particularly the invention relates to adhesive tapes having good scrape abrasion properties while remaining hand-tearable.

### BACKGROUND

Tape is used in applications such as part of a wiring harness for an automobile. Ideally, the tape has excellent scrape abrasion resistance and reasonably can reasonably be torn by hand. Typically, tape has been utilized which, while providing an acceptable level of scrape abrasion resistance is not hand-tearable. Current tapes used in this application require cutting with tools (scissors or knives), both reducing productivity and presenting a safety concern for operators. Thus, there is a need for a tape having excellent scrape abrasion resistance coupled with acceptable hand-tearability.

### BRIEF SUMMARY

The present invention provides a tape containing an unbalanced woven fabric and an adhesive. The woven fabric has a warp dominant face and a filling dominant face, a plurality of warp yarns in a warp direction, and a plurality of filling yarns in a filling direction perpendicular to the warp direction crossing with the warp yarns at a plurality of intersections. At least 55% by number of the intersections have the warp yarn crossing with the filling yarn such that the warp yarn is on the warp dominant face of the fabric. At least 55% by number of the intersections have the warp yarn crossing with the filling yarn such that the filling yarn is on the filling dominant face of the fabric. The warp yarns have a linear mass density of between about 30 and 100 denier and the filling yarns have a linear mass density of between about 70 and 600 denier. The adhesive is adjacent to the warp dominant face of the woven fabric.

### BRIEF DESCRIPTION OF THE DRAWINGS

FIG. 1 illustrates schematically a cross-section of an exemplary adhesive tape.

FIGS. 2-15 illustrate some possible weave patterns of the unbalanced woven fabric.

FIG. 16 illustrates a cross-section of an exemplary fabric.

### DETAILED DESCRIPTION

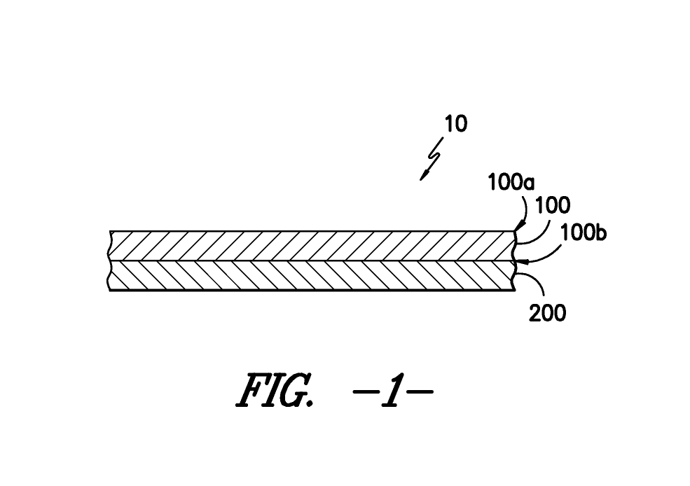

Referring now to FIG. 1, there is shown an embodiment of the unbalanced woven adhesive tape 10 having an unbalanced woven fabric 100 having a filling dominant face 100a and a warp dominant face 100b and an adhesive 200 on the warp dominant face 100b of the woven fabric 100. This tape 10 may be used in any suitable end use such as adhesive tape applications including but not limited to, wire harness tape, medical tape, duct tape, double-sided tape, athletic tape, or any tape requiring a full face fabric.

Preferably, the tape 10 is a wire harness tape. With the recent trend toward performance elevation and function advancement in motor vehicles, electrified products, etc., such products have come to be provided with many electric wires, and wire harnesses are frequently used in wiring. These wire harnesses are systems produced by processing electric wires beforehand so as to have necessary forms, specifically, subjecting wires to branching, connector attachment to ends, etc., and binding the processed electric wires by winding a pressure-sensitive adhesive tape there around. Wire harness tapes preferably have good scrape abrasion resistance, hand-tearability, and noise dampening. All of these properties do not yet exist simultaneously in any one tape currently offered on the market. One of the reasons pushing the trend toward higher performing wire harness tape is the desire by automotive manufacturers to reduce the number of warranty claims for electrical malfunctions related to the ever-growing amount of wiring already mentioned.

The term “tape” as referred to above and below describes supported or unsupported, essentially two-dimensional articles such as sheets, strips, ribbons or die-cut parts (i.e., the extension of the articles in two directions distinctly exceeds the extension in the third direction).

The unbalanced woven fabric 100 is selected to give the desired tear strength, tearing characteristics, tensile strength, and cover. The tape 10 is generally torn across the warp yarns. Smooth, easy tear is more closely related to the tear characteristics of the individual warp yarns and the close proximity of each warp yarn to each other. Ideal tear characteristic is similar to the smooth action of a zipper. In one embodiment, the tape is hand-tearable in both directions (warp and filling). Preferably, the fabric 100 has a tensile strength of between about 10 lbs/inch and 200 lbs/inch, more preferably between about 10 lbs/inch and 100 lbs/inch, more preferably between 20 and 80 lbs/inch.

The fabric 100 is an unbalanced woven fabric. “Unbalanced woven fabric” in this application means that the warp and filling yarns within the woven fabric are not equally balanced between the two faces. Examples of balanced woven fabrics include plain weaves (most common), warp and filling rib weaves, basket weaves, and even-sided twills (2×2, 3×3, etc.—both left and right hand, both regular and broken). Some examples of unbalanced woven fabrics include unbalanced twill weaves (2×1, 3×1, 3×2, 4×1, 5×1, etc.—both left and right hand, both regular and broken), satin weaves, and combinations and derivatives thereof (such as combining an unbalanced twill weave with a plain weave, provided the overall fabric still maintains at least 55% by number of the intersections having the warp yarn crossing with the filling yarn such that the warp yarn is on the warp dominant face of the fabric.

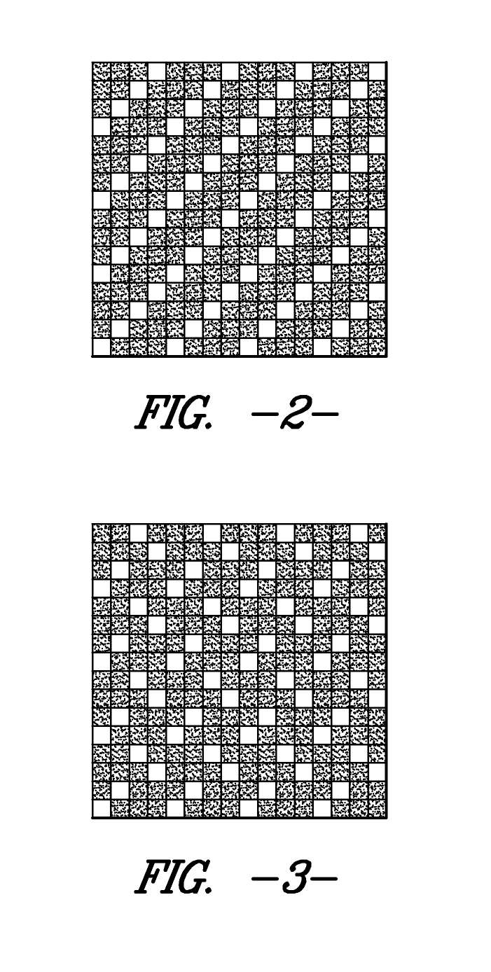

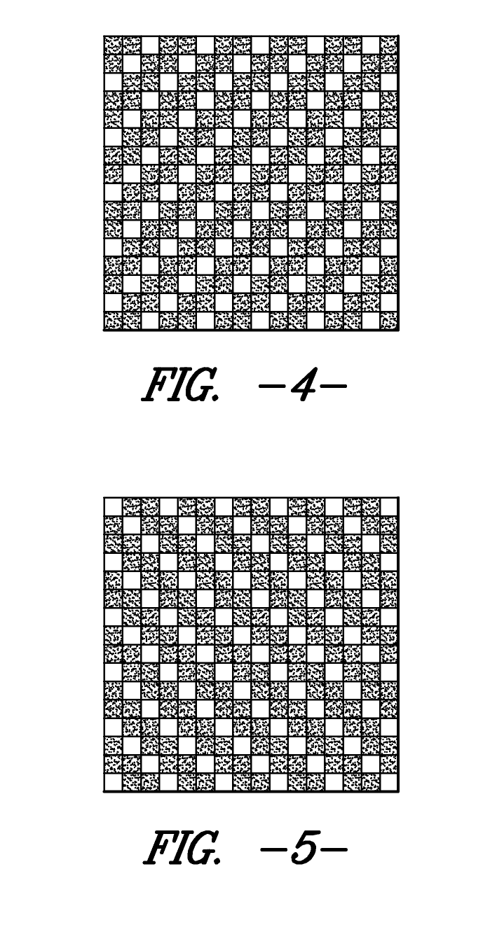

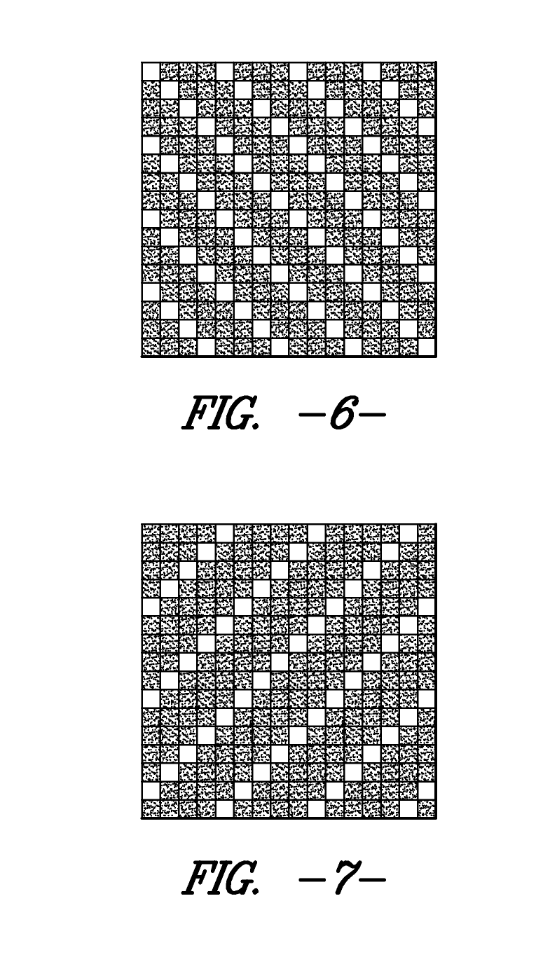

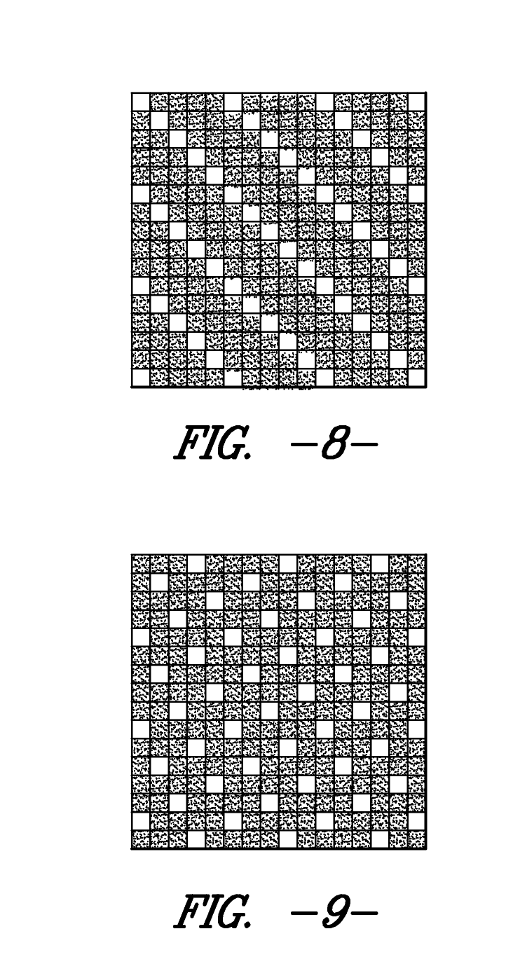

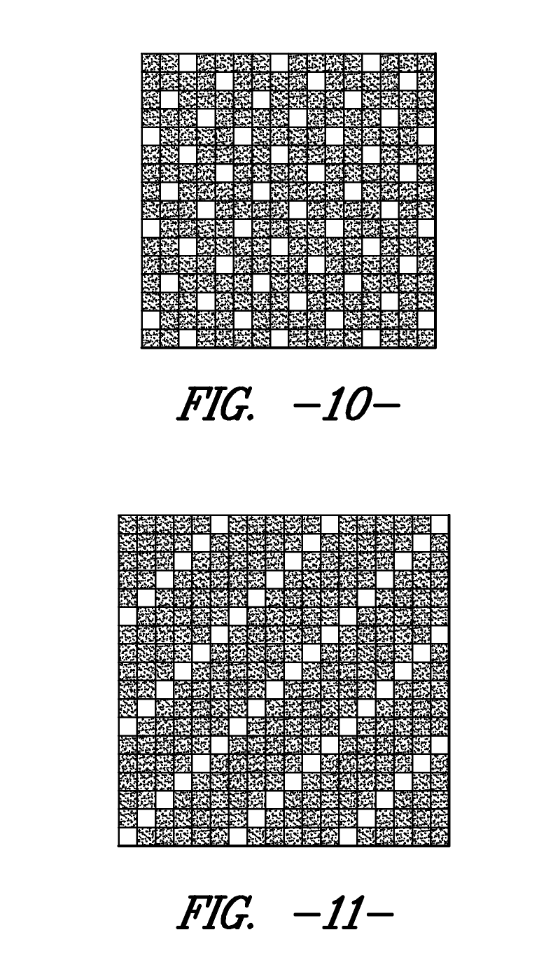

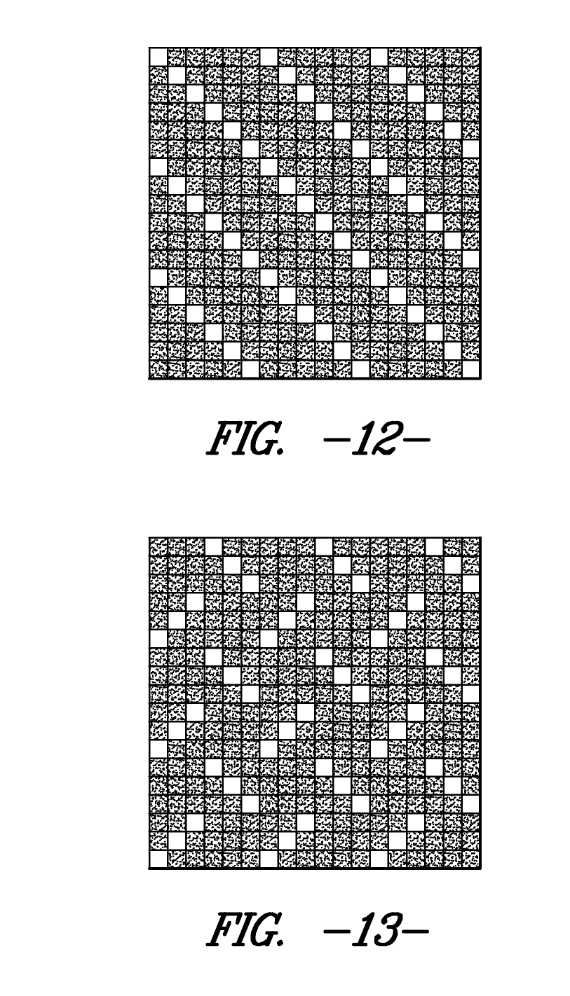

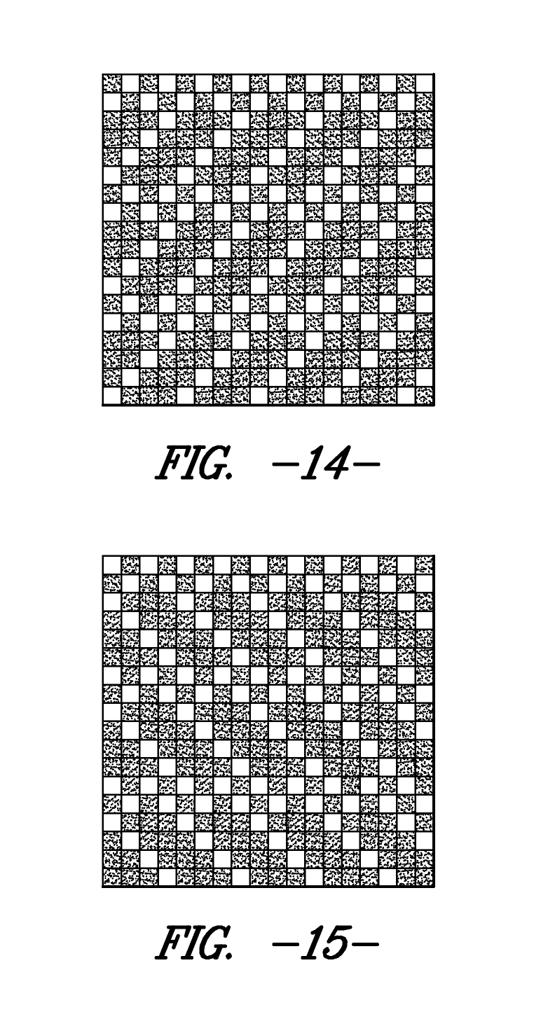

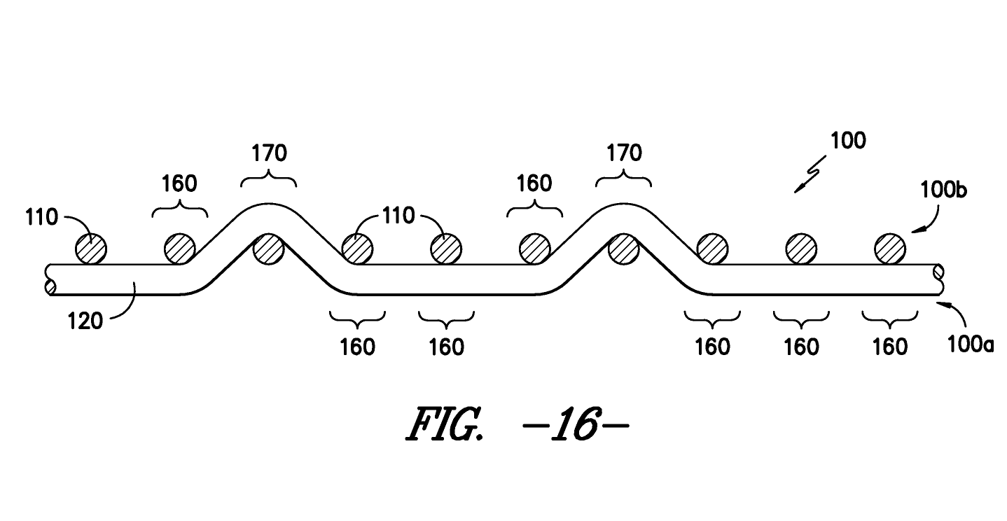

FIGS. 2-15 illustrate some possible weave patterns for the unbalanced woven fabric. In these figures, the white blocks represent the filling yarns being on top at an intersection and the black blocks represent the warp yarns being on top at an intersection. The following chart enumerates the weave patterns shown in the Figures.

| | |
|---|---|
| FIG. 2 | 3 × 1 Right Hand Twill Weave |
| FIG. 3 | 3 × 1 Broken Twill Weave |
| FIG. 4 | 2 × 1 Right Hand Twill Weave |
| FIG. 5 | 2 × 1 Left Hand Twill Weave |
| FIG. 6 | 3 × 1 Left Hand Twill Weave |
| FIG. 7 | 4 × 1 Right Hand Twill |
| FIG. 8 | 4 × 1 Left Hand Twill |
| FIG. 9 | 4 × 1 Satin (Counter = 3) |
| FIG. 10 | 4 × 1 Satin (Counter = 2) |
| FIG. 11 | 5 × 1 Right Hand Twill |
| FIG. 12 | 5 × 1 Left Hand Twill |
| FIG. 13 | 5 × 1 Broken Twill |
| FIG. 14 | 3 × 1 + 1 × 1 (Right Hand) |
| FIG. 15 | 3 × 1 + 1 × 1 (Left Hand) |

In the different weaves shown, the longer the floats of the warp yarns, the more filling yarns of the same physical size that can be packed into the fabric (compared with the same sets of yarn sizes in more balanced weaves), creating a larger and larger differential between the properties of each face of the fabric. Typically, the longer the warp floats, the more difficult the fabric will be to tear (all else the same). This is because longer floats give the warp yarns greater mobility, allowing multiple yarns to group together and act as one to resist the propagation of a tear. In a plain weave, for example, the warp and filling yarns are tied together (swapping position) at all possible intersections, restricting the ability of individual yarns to move out of the way and avoid the stress concentrations at the leading edge of a tear. A plain weave is therefore the easiest weave to tear (if weave configuration is the only variable). The increased difficulty of tearing non-plain weaves can be tempered by using smaller and weaker yarns in the warp direction than may otherwise be typical. Regardless of the weave, mobility of the warp yarns is also partially restricted by the adhesive applied during tape manufacture, meaning a finished tape will be easier to tear than the untreated fabric component that goes into the tape. However, as already indicated, by increasing the length of the warp floats, it also becomes possible to weave higher densities of filling yarns (with density in this case referring to the number of yarns present per unit length of woven fabric). This can lead to favorable scrape abrasion properties by creating a very dense surface of what may be quite coarse filling yarns. The filling dominant face of the unbalanced woven fabric 100 would typically be intended to be the face presented to the external environment in end-use application. Thus, the ability to tear the final product by hand comes from using fine, weak yarns in the warp direction, and the vast majority of the resistance to scrape abrasion comes from using a high density of possibly coarse filling yarns on a filling-dominated face presented to the external environment. Only the face of the tape that will be exposed to external wear in end use is required to pass the scrape abrasion test.

The greater the percentage of filling yarn exposure on the filling dominant face of the fabric, the stronger the color perception if colored filling yarns (black or otherwise) are used in conjunction with “natural” white warp yarns. It is believed that there is a niche market for custom-colored wire harness tapes (orange, blue, and gray have been mentioned), and one way to accomplish this may be to use either solution-dyed or package-dyed yarns of sufficient size in the filling direction across a white warp. If the weave is sufficiently unbalanced and a high enough pick density of large filling yarns is used (relative to smaller warp yarns), the need for very expensive and flexibility-limiting custom warp colors should be successfully avoided, as the color of the warp yarn on the filling dominant face of the fabric presented should be visually almost imperceptible.

The unbalanced woven fabric 100 contains a plurality of warp yarns running in a first direction and a plurality of filling yarns running in a second direction which is perpendicular to the first direction. Where the warp yarns and filling yarns cross each other, intersections are formed. In each intersection, the warp yarns may pass over the filling yarns or under the filling yarns. How the yarns are arranged at the intersections results in how the warp yarns and filling yarns are arranged on the fabric faces. In an unbalanced woven fabric, one of the faces of the fabric has a predominance of warp yarns forming the warp dominant face and one of the faces of the fabric has a predominance of filling yarns forming the filling dominant face.

FIG. 16 is an illustration of a cross-section of one unbalanced woven fabric 100. The unbalanced woven fabric 100 has a plurality of warp yarns 110 and a plurality of filling yarns 120 (only one shown for simplicity). Each place where the warp yarns and the filling yarn cross each other forms an intersection 160, 170. In each intersection, the warp yarns 110 may pass over or under the filling yarn 120. In the case of intersections 160, the warp yarns 110 pass over the filling yarn 120 such that the warp yarn is on the warp dominant face 100b of the unbalanced woven fabric 100 and the filling yarn is on the filling dominant face 100a. In the case of intersections 170, the filling yarn 120 passes over the warp yarns 120 such that the filling yarn is on the warp dominant face 100b of the unbalanced woven fabric 100 and the warp yarns 110 are on the filling dominant face 100a. The resultant fabric 100 has an uneven distribution of warp and filling yarns across its faces.

In one embodiment, in at least 55% of the intersections of the fabric, the warp yarns cross over the filling yarns such that the warp yarn is on the warp dominant face and in at least 55% of the intersections of the fabric, the filling yarns cross over the warp yarns such that the filling yarn is on the filling dominant face. In one embodiment, in at least 60% of the intersections of the fabric, the warp yarns cross over the filling yarns such that the warp yarn is on the warp dominant face and in at least 60% of the intersections of the fabric, the filling yarns cross over the warp yarns such that the filling yarn is on the filling dominant face. In another embodiment, in at least 75% of the intersections of the fabric, the warp yarns cross over the filling yarns such that the warp yarn is on the warp dominant face and in at least 75% of the intersections of the fabric, the filling yarns cross over the warp yarns such that the filling yarn is on the filling dominant face. In another embodiment, in at least 80% of the intersections of the fabric, the warp yarns cross over the filling yarns such that the warp yarn is on the warp dominant face and in at least 80% of the intersections of the fabric, the filling yarns cross over the warp yarns such that the filling yarn is on the filling dominant face.

The unbalanced woven fabric 100 contains warp yarns and filling yarns that may be made out of any suitable material. The warp yarns and/or the filling yarns may be, but are not limited to, polyester, polypropylene, polyethylene, cotton, rayon, polyamide, aramids (including meta and para forms), nylon, polyvinyl acetate, polyvinyl alcohol, nylon (including nylon 6, nylon 6,6, and nylon 4,6), PBO, PEN, PLA, fiberglass, acetate, and flax. The warp yarns may be made of the same or different yarn material than the filling yarns. In one embodiment, the warp yarns and the filling yarns contain polyester. Polyester is preferred due to its high strength and low cost, and favorable thermal properties. The warp yarns and filling yarns may have any cross-sectional shape including round, elliptical, square, tape shaped, tear-shaped, crescent-shaped, rectangular, regular or irregular, and multi-lobal. The warp and filling yarns may be continuous or staple and may be monofilament, multifilament (any number of filaments), or spun. Preferably, the warp and filling yarns are continuous multifilament yarns. Having a continuous yarn versus a staple yarn may result in better abrasion properties. Multifilament yarns may produce better abrasion resistance, as the filaments of the multifilament yarns may move and shift to form a smoother surface. In one embodiment, the warp yarns and/or the filling yarns have no sizing or other protective ingredients and are not subjected to a slashing or single-end sizing operation. Alternatively, the warp yarns and/or the filling yarns may be sized and/or processed with a slashing or single-end sizing process.

The linear mass density of the warp yarns and the filling yarns may be any density suitable for the end product. In one embodiment, the warp yarns have a linear mass density of between about 30 and 100 denier. More preferred, the warp yarns have a linear mass density of between about 40 and 70 denier. In one embodiment, the filling yarns have a linear mass density of between about 70 and 600 denier. More preferred the warp yarns have a linear mass density of between about 150 and 450 denier. In the unbalanced woven fabric 100, the warp yarns contribute to the hand-tearability of the fabric 100. If the warp yarns had a very large denier, then the fabric may lose some of its hand-tearability properties. The filling yarns contribute to the scrape abrasion resistance of the fabric 100. If the filling yarns had a very low denier, the fabric may lose some of its abrasion resistance characteristics. An optional step involves calendering the fabric prior to adhesive coating.

The warp and filling yarns in the unbalanced woven fabric 100 may be present in any density suitable for weaving. In one embodiment, the unbalanced woven fabric contains between about 50 and 200 warp ends per inch and between about 40 and 130 filling picks per inch. The specific amount of ends and picks per inch can be varied to affect abrasion resistance and hand tearability. Maximum yarn densities (fabric construction density, not linear mass density) are controlled by the denier of the yarns used, the specific weave design selected, and the capabilities of the fabric processing and preparation equipment. Minimum yarn densities are typically determined by fabric permeability, with adhesive bleed-through being a primary concern.

In another embodiment, the unbalanced woven fabric is used as a very high abrasion resistant fabric, which may or may not be hand-tearable, but is preferably hand-tearable. This high abrasion resistant fabric may have to have a scrape abrasion resistance of greater than 2000, 3000, or even 5000 cycles with transfer adhesive backing as measured by ISO 6722(E)-Scape Abrasion Test. In this fabric, it may be preferable to have even longer floats (meaning 5×1, 6×1, etc. construction). In one embodiment for the high abrasion resistant fabric the fabric may have warp yarns with a denier of between 40 and 150, filling yarns with a denier of between 300 and 1000, between about 60 and 150 warp ends per inch, and between about 30 and 150 filling picks per inch.

In one embodiment, both the warp yarns and the filling yarns are solution-dyed, preferably black. The outward-facing surface of wire harness tapes is typically required to be black by the automotive industry. In one embodiment, the filling yarns are solution-dyed and the warp yarns are not solution-dyed (i.e. they are their natural color, white). For this embodiment, because the fabric is an unbalanced weave, a majority of yarns on the face of the tape visible to the consumer (the filling dominant face) are the black filling yarns, and the white warp yarns are mostly hidden. An unbalanced weave enables the use of the “natural” or un-dyed warp yarns, resulting in significant cost savings while preserving the color of the resultant tape. The filling and/or warp yarns may also be colored in any other color other than black. Solution-dyed filling yarns are a good option if available, but package-dyed yarns would likely be more cost-effective for smaller lots of custom colors.

Referring back to FIG. 1, an adhesive 200 is adjacent the warp dominant face 100b of the unbalanced woven fabric 100. While it is shown that one layer of adhesive 200 is used and it is only on the warp dominant face 100b of the unbalanced woven fabric 100, the adhesive may contain any number of suitable layers and may be on both faces 100a, 100b of the fabric 100 or may only be on the filling dominant face 100a according to the desired end product.

The adhesive 200 may be any suitable adhesive and may be applied in any suitable manner. The adhesive may be applied to just the surface of the fabric 100, may penetrate a set percentage into the fabric 100, or migrate through the fabric onto the face opposite initial application. Different adhesives may be used on either face. The adhesive 200 may be any suitable adhesive including but not limited to pressure-sensitive, heat-cured and UV-cured. Preferably, the adhesive 200 is a pressure-sensitive adhesive. Examples of pressure-sensitive adhesives that can be used in the present invention include rubber pressure-sensitive adhesives (natural rubber, polyisoprene rubber, styrene-butadiene rubber, SIS-, SBS- or SEBS-block rubber, butyl rubber, polyisobutylene rubber, reclaimed rubber), rubber gum adhesives, non-latex-based synthetic adhesives acrylic pressure-sensitive adhesives and silicone pressure-sensitive adhesives. The pressure-sensitive adhesive 200 is preferably tacky at room temperature and can be applied to a wide variety of substrates by exerting, for example, finger pressure.

The pressure-sensitive adhesive 200 may be applied to the woven fabric 100 by any suitable method, such as but not limited to, solvent coating in a continuous or discontinuous method, roller coating, air knife coating, rod coating, electrostatic coating, slide hopper coating, extrusion coating, blade coating, curtain coating, and slide coating.

In one embodiment, the unbalanced woven adhesive tape 10 has a release agent in contact with the pressure-sensitive adhesive 200. The release agent may be release liner, release chemical, or other material facilitating release of the pressure-sensitive adhesive off of a liner or application (such as skin). If the release agent is a liner, the release liner should be chosen such that the release liner may easily be stripped off the tape 10 without damaging the tape 10. Examples of suitable materials for use as a release liners include, e.g., paper (e.g., kraft paper), polymer films (e.g., polyethylene, polypropylene and polyester), composite liners, and combinations thereof that may optionally have a silicone or silicone-containing material, a fluorinated or fluorine-containing material, or a Page of fluorosilicone material on at least one of the surfaces. One example of a useful release liner is a fluoroalkyl silicone polycoated paper. In some constructions, the release liner includes a kraft paper sandwiched between two polymer films that have been treated to exhibit release properties. Release liners can optionally include a variety of markings and indicia including, e.g., lines, art work, brand indicia, and other information.

In one embodiment, the unbalanced woven fabric 100 is calendered. Calendering uses heat and pressure to smooth out the surface of the fabric and impart other physical changes. Calendering is preferably accomplished using at least one heated roller, where the fabric passes into a nip formed by the heated roller and another roller where the heat and pressure are applied. Heated roller surface temperatures can range anywhere from ambient temperature up to around 440 degrees Fahrenheit. Pressures along the nip point can range anywhere from 100 pounds per linear inch up to 1400 pounds per linear inch or more. The heat may be applied directly to one or both faces of the fabric. Preferably, the heat is applied to the filling dominant face of the fabric. The heat and pressure impact both faces of the fabric, but the smoothing effects are more pronounced on the face of the fabric in direct contact with the heated roll. Calendering may also be accomplished by any other means of delivering heat and pressure to the fabric such as a heated platen or heated belt laminator. Beyond smoothing the surface, other physical changes imparted to fabric during the calendering process include gauge (thickness) reduction, reduced air permeability, better coverage (yarn cross-sections become flattened and spread out), and improved tear properties (easier to tear by hand versus an non-calendered fabric constructed in the same manner). Further, in smoothing the fabric surface to such extremes, improvements in scrape abrasion resistance may be realized.

In one embodiment, the unbalanced woven fabric 100 and the unbalanced woven adhesive tape 10 have an abrasion resistance of at least 200 cycles to failure with transfer adhesive backing as measured by ISO 6722(E)-Scape Abrasion Test. Having a resistance of at least about 200 cycles to failure enables the fabric to be used as part of a wire harness tape and allows the tape to be used as wire harness tape, though the grade of tape into which it can be marketed and sold is dependent on the test values of the finished tape alone. Different wear categories of tape correlate with different scrape abrasion cycle thresholds (0=<100, 1=100-499, 2=500-999, 3=1000-4999, 4=>4999). The unbalanced woven fabric 100 and the unbalanced woven adhesive tape 10 are preferably hand-tearable, meaning that one can tear the fabric and/or tape using just hand force across the warp direction of the fabric/tape. Having a hand-tearable tape is desired as it eliminates the need for cutting the tape with a knife or scissors, saving production time and increasing safety. The application of adhesive to a previously untreated fabric assists in locking the yarns, and the fibers within said yarns in place, minimizing slippage, thereby preventing the yarns and fibers from getting out of the way of the stress concentrations at the leading edge of the propagation of the tear. For this reason, it will be easier to tear a finished piece of tape than an untreated piece of the component fabric.

In another embodiment, the tape 10 has noise-dampening properties. In certain areas of an automobile, the wire harness may be subjected to vibrations and jarring that could cause it to knock against adjacent surfaces such as the frame of the vehicle. This can translate into unwanted noise within the interior space of the vehicle. Wire harnesses located in such areas of concern may require wrapping with a tape that has proven noise-dampening properties. Using unbalanced weaves as proposed for addressing the problem of abrasion resistance has also been demonstrated to provide good noise-dampening properties. However, the needed noise-dampening properties can generally be achieved using much lower fabric constructions (fewer ends and picks per inch). A tape meeting high scrape abrasion resistance requirements is likely to have good noise dampening properties, but the reverse is not necessarily true (that is, a tape with good noise-dampening characteristics does not necessarily have a high scrape abrasion resistance).

In one embodiment, the woven fabric 100 may have a thermoplastic layer on the face of the fabric 100 opposite the adhesive 200. This thermoplastic layer is preferably polyethylene and allows the pressure-sensitive adhesive tape 10 to be used in applications such as duct tape.

Other additives may be present in the warp yarns, weft yarns, and/or adhesive to provide other properties to the tape 10. These other additives include, but are not limited to colorants, flame retardants, antimicrobial agents, wetting agents, surfactants, and odor control agents. It may be important to some end use application to have the tape be fire resistant, and any known method for making yarns, fabric, or tapes fire resistant (such as an FR additive in the material to form the yarns or a coating on the fabric) may be used.

### EXAMPLES

### Example 1

A 3×1 broken twill woven fabric was formed using 70 denier continuous multifilament polyester warp yarns and 150 denier continuous multifilament filling yarns. The fabric had 90 ends per inch and 130 picks per inch. Because a 3×1 broken twill weave was used, in about 75% of the intersections in the fabric, the warp yarns cross over the filling yarns such that the warp yarn is on the warp dominant face and the filling yarns cross over the warp yarns such that the filling yarn is on the filling dominant face.

With a lab-applied transfer adhesive backing, the fabric tested to an average of 1347 cycles to scrape abrasion failure on the filling dominant face, and an average of 362 cycles to scrape abrasion failure on the warp dominant face, with the needle traversing back and forth in the warp yarn direction in both cases.

In all cases, the test results obtained with solvent-based adhesives applied on a production line have proven superior to lab testing with a transfer adhesive. The transfer adhesive is not applied in liquid state, and therefore imparts significantly fewer yarn and fiber fixation properties. Obtaining a value in excess of 1000 cycles with the transfer adhesive indicates the values obtained in a production run will almost certainly reliably exceed the desired 1000 cycle threshold. Eventual tearability in tape form can be simulated by taking untreated fabric and soaking it in hairspray or a similar solution, allowing it to dry, and then attempting to tear the fabric. If the fabric can be torn by hand in this manner, it is highly likely that a manufactured tape using the same fabric as a component will also be able to be torn by hand. The fabric described above was successfully torn using the hairspray test.

### Example 2

A plain woven fabric was formed using 70 denier continuous multifilament polyester warp yarns and 150 denier continuous multifilament filling yarns. The fabric had 60 ends per inch and picks per inch. Because a plain weave was used, the fabric was not considered unbalanced.

With a lab-applied transfer adhesive backing, the fabric tested to an average of only 16 cycles to scrape abrasion failure with the needle traversing back and forth in the warp yarn direction. Again, because the weave was balanced in this case, there was no warp dominant face and filling dominant face. Both faces of the cloth were the same. The fabric described in this example was not only tested on the lab scale with transfer adhesive, but was manufactured in sufficient quantity to be converted into tape using production processes. When the same fabric had solvent-based adhesives applied to one face during manufacture, the scrape abrasion test was re-run. The finished tape tested to an average of around 175 cycles to scrape abrasion failure with the needle traversing back and forth in the warp yarn direction. The range of all tests conducted yielded some values in excess of 200 cycles. This result demonstrates a significant improvement in abrasion resistance on a manufactured tape when compared with the same fabric component tested with a lab-applied transfer adhesive backing. More work is needed to determine whether this improvement in abrasion resistance is scalable (e.g. tenfold improvement versus transfer adhesive) or fixed (e.g. +200 cycle improvement versus transfer adhesive). Regardless, testing fabrics with a lab-applied transfer adhesive backing serves as a convenient way to compare the relative scrape abrasion performance of different types of fabrics. The fabric described above was also successfully torn by hand using the aforementioned hairspray test. The validity of this simulation was empirically verified by conclusive hand-tearability after the same fabric was manufactured into tape form (with a straight slit edge).

### Example 3

A 3×1 broken twill woven fabric was formed using 100 denier continuous multifilament polyester warp yarns and 300 denier continuous multifilament filling yarns. The fabric had 90 ends per inch and 85 picks per inch. Because a 3×1 broken twill weave was used, in about 75% of the intersections of the fabric, the warp yarns cross over the filling yarns such that the warp yarn is on the warp dominant face and the filling yarns cross over the warp yarns such that the filling yarn is on the filling dominant face.

With a lab-applied transfer adhesive backing, the fabric tested to an average of 4501 cycles to scrape abrasion failure on the filling dominant face, and an average of 2775 cycles to scrape abrasion failure on the warp dominant face, with the needle traversing back and forth in the warp yarn direction in both cases. The fabric was not able to be easily torn by hand using the hairspray test.

### Example 4

A 3×1 broken twill woven fabric was formed using 70 denier continuous multifilament polyester warp yarns and 450 denier continuous multifilament filling yarns. The fabric had 90 ends per inch and 80 picks per inch. Because a 3×1 broken twill weave was used, in about 75% of the intersections of the fabric, the warp yarns cross over the filling yarns such that the warp yarn is on the warp dominant face and the filling yarns cross over the warp yarns such that the filling yarn is on the filling dominant face.

With a lab-applied transfer adhesive backing, the fabric tested to an average of 3636 cycles to scrape abrasion failure on the filling dominant face with the needle traversing back and forth in the warp yarn direction. The fabric was able to be torn by hand using the hairspray test

### Example 5

A 3×1 broken twill woven fabric was formed using 40 denier continuous multifilament polyester warp yarns and 300 denier continuous multifilament filling yarns. The fabric had 112 ends per inch and 80 picks per inch. Because a 3×1 broken twill weave was used, in about 75% of the intersections of the fabric, the warp yarns cross over the filling yarns such that the warp yarn is on the warp dominant face and the filling yarns cross over the warp yarns such that the filling yarn is on the filling dominant face.

With a lab-applied transfer adhesive backing, the fabric tested to an average of 340 cycles to scrape abrasion failure on the filling dominant face with the needle traversing back and forth in the warp yarn direction. A lab-applied solvent-based drawdown was also done on the same fabric. The solvent-based drawdown yielded an average scrape abrasion test result of 1417 cycles to failure on the filling dominant face with the needed traversing back and forth in the warp yarn direction. The fabric was able to be easily torn by hand using the hairspray test.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tape comprising:
an unbalanced woven fabric having an warp dominant face and a filling dominant face, wherein the woven fabric comprises a plurality of warp yarns in a warp direction and a plurality of filling yarns in a filling direction perpendicular to the warp direction crossing with the warp yarns at a plurality of intersections,
wherein at least 55% by number of the intersections have the warp yarn crossing with the filling yarn such that the warp yarn is on the warp dominant face of the fabric and at least 55% by number of the intersections have the warp yarn crossing with the filling yarn such that the filling yarn is on the filling dominant face of the fabric, wherein the warp yarns have a linear mass density of between about 30 and 100 denier and the filling yarns have a linear mass density of between about 70 and 600 denier; and,
an adhesive adjacent to the warp dominant face of the woven fabric.

2. The tape of claim 1, wherein the warp yarns have a linear mass density of between about 40 and 70 denier.

3. The tape of claim 1, wherein the filling yarns have a linear mass density of between about 150 and 450 denier.

4. The tape of claim 1, wherein the woven fabric is a twill weave fabric.

5. The tape of claim 4, wherein the twill weave fabric is a broken twill weave fabric.

6. The tape of claim 1, wherein the woven fabric is a satin weave fabric.

7. The tape of claim 1, wherein at least 75% by number of the intersections have the warp yarn crossing with the filling yarn such that the warp yarn is on the warp dominant face of the fabric.

8. The tape of claim 1, wherein at least 75% by number of the intersections have the warp yarn crossing with the filling yarn such that the filling yarn is on the filling dominant face of the fabric.

9. The tape of claim 1, wherein the upper surface of the woven has an abrasion resistance of at least 200 cycles with transfer adhesive backing as measured by ISO 6722(E)—Scrape Abrasion Test.

10. The tape of claim 1, wherein the woven fabric comprises between about 50 and 200 warp ends per inch

11. The tape of claim 1, wherein the woven fabric contains about 40 and 130 filling picks per inch.

12. The tape of claim 1, wherein the adhesive is a pressure sensitive adhesive.

13. The tape of claim 1, further comprising a release agent on the adhesive on the side of the adhesive opposite the woven fabric reinforcement.

14. The tape of claim 13, where the release agent is a release liner.

15. The tape of claim 1, wherein the woven fabric is hand-tearable.

16. The tape of claim 1, wherein the tape is hand-tearable.

17. The tape of claim 1, wherein the filling yarns are solution-dyed and the warp yarns are not solution-dyed.

18. The tape of claim 1, wherein the warp yarns and filling yarns are continuous polyester yarns.

19. A process for forming a calendered tape comprising:
weaving an unbalanced woven fabric having an warp dominant face and a filling dominant face, wherein the woven fabric comprises a plurality of warp yarns in a warp direction and a plurality of filling yarns in a filling direction perpendicular to the warp direction crossing with the warp yarns at a plurality of intersections, wherein at least 60% by number of the intersections have the warp yarn crossing with the filling yarn such that the warp yarn is on the warp dominant face of the fabric and at least 60% by number of the intersections have the warp yarn crossing with the filling yarn such that the filling yarn is on the filling dominant face of the fabric, wherein the warp yarns have a linear mass density of between about 30 and 100 denier and the filling yarns have a linear mass density of between about 70 and 600 denier;
calendering the unbalanced woven fabric; and,
applying an adhesive to the warp dominant face of the unbalanced woven fabric.

20. The process of claim 19, wherein the twill weave fabric is a broken twill weave fabric.
